(19) United States
(12) Patent Application Publication
(10) Pub. No.: US 2014/0358737 A1
(43) Pub. Date: Dec. 4, 2014

(54) Clothing Style Selection and Matching E-Commerce & Game Interface

(71) Applicant: Alexander James Burke, Upper Montclair, NJ (US)

(72) Inventor: Alexander James Burke, Upper Montclair, NJ (US)

(21) Appl. No.: 14/287,078

(22) Filed: May 26, 2014

Related U.S. Application Data
(60) Provisional application No. 61/830,205, filed on Jun. 3, 2013.

(51) Int. Cl. G06Q 30/06; A41D 1/00

(52) U.S. Cl. CPC G06Q 30/0643; A41D 1/00
USPC 705/27.2

(57) ABSTRACT

A clothing style selection display image includes, first and second windows enabling a user to select a top dress item and a bottom dress item respectively and a match zone. The match zone presents a selected top dress item and a bottom dress item adjacent, in response to user selection of the selected top dress item and the selected bottom dress item in the first and second windows respectively. In a clothing style selection and matching game embodiment, the display image presents an indicator of degree of match of dress items in the match zone with a winner having best match. In another game embodiment, the display image presents multiple different match zones with a winner matching dress items in the multiple different match zones fastest. The match zone presents the selected top dress item and the bottom dress item with substantially matching waist size.

This is a non-provisional application claiming priority of provisional application Ser. No. 61/830,205 by A. J. Burke, filed 3 Jun. 2013.

### TECHNICAL FIELD

This invention concerns a clothing style selection, matching and game system.

### BACKGROUND

Known ecommerce fashion retail Internet sites show mixtures of clothing items in a single window and enable a user to employ cumbersome drag and drop operations to move pictures of the clothing items of different sizes to be adjacent. Such known fashion retail Internet sites fail to facilitate clothing selection and matching and are difficult to use. Known sites lack game functions addressing clothes matching.

### SUMMARY

A clothing style selection and matching system and web site enables a user to match and select clothes for purchase. A game function additionally generates awareness and drives traffic to the web site. A clothing style selection and matching interface is provided in response to machine executable instructions stored in a tangible medium. The interface comprises data representing a single display image including, a first window enabling a user to select a top dress item from multiple different displayed top dress items, a second window enabling a user to select a bottom dress item from multiple different displayed bottom dress items and a match zone. The match zone presents a selected top dress item and a bottom dress item adjacent, in response to user selection of the selected top dress item and the selected bottom dress item in the first and second windows respectively. The match zone presents the selected top dress item and the bottom dress item with substantially matching waist size.

In a feature, a clothing style selection and matching game is provided in response to machine executable instructions stored in a tangible medium. In the game, the display image presents an indicator of degree of match of dress items in the match zone with a winner having best match. In another game embodiment, the display image presents multiple different match zones with a winner matching dress items in the multiple different match zones fastest.

### BRIEF DESCRIPTION OF THE DRAWINGS

In the drawing:

FIG. 1 shows a clothing style selection, matching and game system, according to invention principles.

FIG. 2 shows a flowchart of a process used by the system for matching top and bottom dress items, according to invention principles.

FIG. 3 shows a flowchart of a process used by the system for providing a clothing database used by the system for matching top and bottom dress items, according to invention principles.

FIG. 4 shows a flowchart of a process used by the system for providing a game, according to invention principles.

FIG. 5 shows a single display image for presenting selected dress items adjacent to facilitate matching and clothing selection, according to invention principles.

FIG. 6 shows a single display image for presenting selected dress items adjacent illustrating seller selection and bottom dress item category selection and cart and checkout functions, according to invention principles.

FIG. 7 shows a single display image for presenting selected dress items adjacent illustrating top dress item category selection and cart and checkout functions, according to invention principles.

FIG. 8 shows a single display image for presenting selected dress items adjacent illustrating seller and top dress item selection for addition to a cart with shipping amounts, according to invention principles.

FIG. 9 shows a single display image for presenting selected top and bottom dress items as well as shoes and accessories (e.g., bags) adjacent, according to invention principles.

FIG. 10 shows a single display image for presenting multiple selected dress item matching zones for a game mode, according to invention principles.

FIG. 11 shows a flowchart of a process used by a clothing style selection, matching and game system, according to invention principles.

### DETAILED DESCRIPTION OF THE DRAWINGS

A system provides a clothing style selection and matching display interface (e.g., at least one web page) and game function. The system in one embodiment enables a user to view dress items e.g. tops and bottoms in separate concurrently displayed windows and advantageously select an item from each window for automatic presentation in a clothing match zone with visually compatible waist size enabling a user to assess the items as a single outfit. The waist size is sufficiently compatible to eliminate a need for scaling of a dress item for easy viewing and matching of clothes. The system also eliminates a need for drag and drop of a clothes item to a match zone as in response to a selection of an item the selected item is automatically incorporated in a designated area of the match zone. In one embodiment, the match zone presents the selected top dress item and the bottom dress item on a representation of a human model of size selected in response to user entered size data (e.g. dress size, height, weight, shoe size, for example). A video clip of the dressed model is also shown walking a fashion runway. The term “substantially matching” as used herein means compatible and harmonious in a fashion sense and without clashing. The term “substantially” herein means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In a game embodiment, a clothing style selection and matching game presents an indicator of degree of match of dress items in the match zone with a winner having best match. In another game embodiment, the display image presents multiple different match zones with a winner matching dress items in the multiple different match zones fastest.

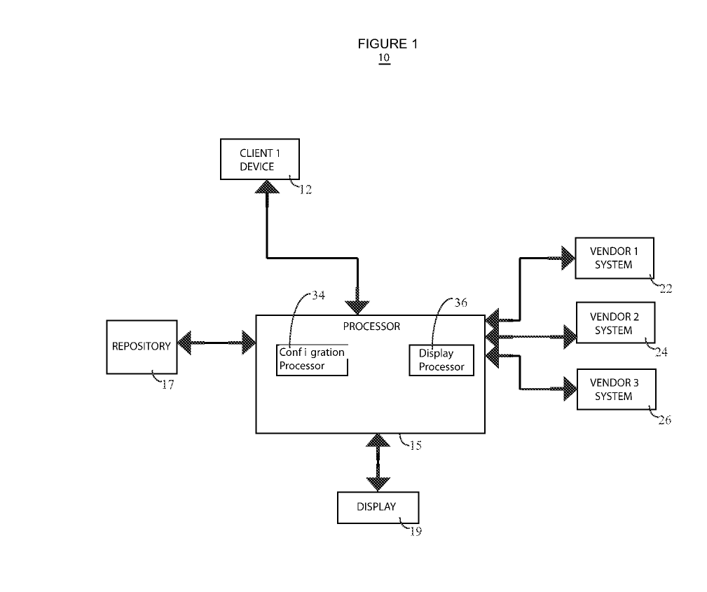

FIG. 1 shows a clothing style selection, matching display and game system 10 comprising at least one processor 15 (processing device, computer or server) communicating with display 19, at least one repository 17, client application and device 12 including a display enabling an individual user to select and match clothes with an advantageous user friendly interface. At least one processor 15 (computer or server) also communicates via the Internet with remote clothes seller systems 22, 24 and 26 for accessing web pages showing selected seller clothing items for order fulfillment and placing orders for these items. Any part or the whole of processor 15, repository 17 and display 19 may be located at client device 12 or at a remote server in different system embodiments.

Display processor 36 provides data representing a single display image including, a first scrollable window enabling a user to select a top dress item from multiple different displayed top dress items, a second scrollable window enabling a user to select a bottom dress item from multiple different displayed bottom dress items and a match zone. The match zone presents a selected top dress item and a bottom dress item adjacent and with substantially matching waist size by transformation image representations of at least one of the dress items by rotation, scaling and translation operations, in response to user selection of the selected top dress item and the selected bottom dress item in the first and second windows respectively. Configuration processor 34 enables a user to select clothes from particular sellers for incorporation in the first and second windows. Particular sellers may comprise teenage dress item sellers, pre-teen dress item sellers, haute couture sellers and dress item sellers associated with particular size, fashion, function, sport or activity, for example.

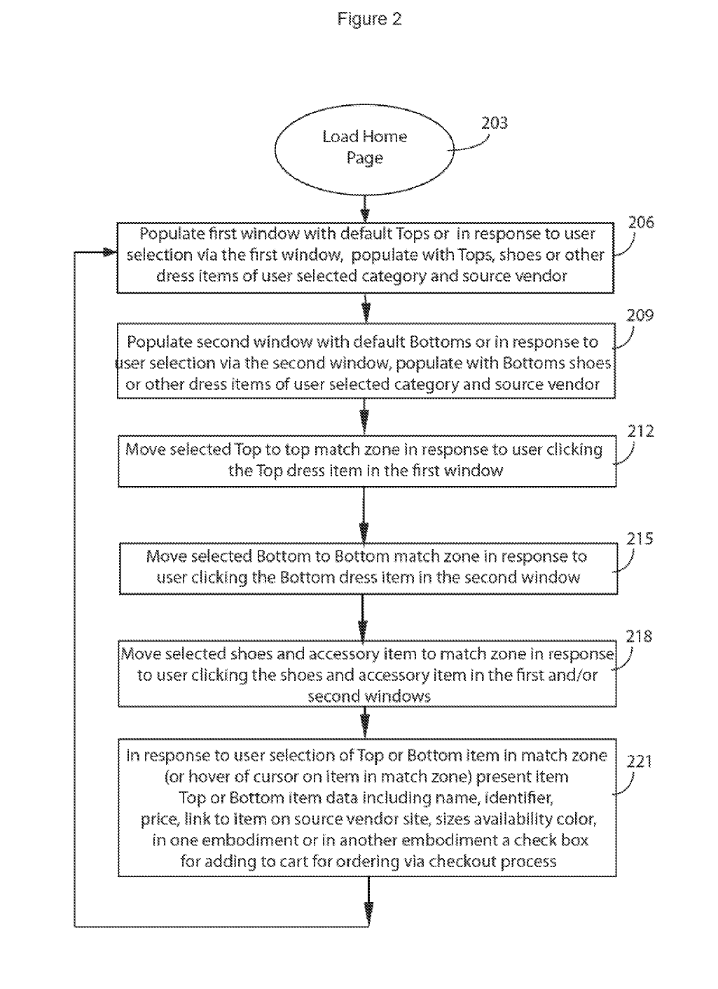

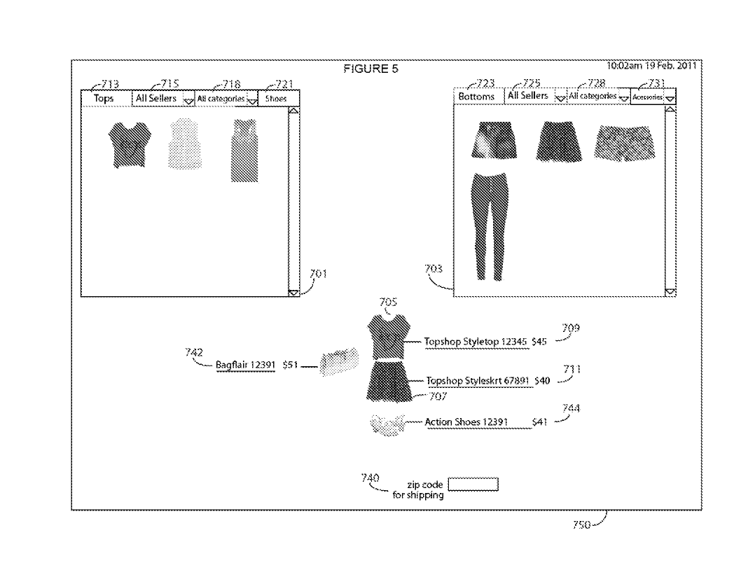

FIG. 2 shows a flowchart of a process used by system 10 (FIG. 1) for matching top and bottom dress items. In step 203, processor 15 initiates presentation of single display image (e.g., web page) 750 (FIG. 5). In step 206, processor 15 populates first scrollable window 701 with default (predetermined) top dress items. User selectable tab 713 is a selectable option list and is configurable using processor 34 to represent a different type of clothing such as sportswear, activity specific clothes and seasonal clothing, for example. User selectable tab 715 enables a user to access an option list for selection of all or one or more different sellers such as Aeropostale™ as sources of the top dress items shown in window 701. User selectable tab 718 enables a user to select a category of clothes shown in window 701 and user selectable tab 721 enables a user to select shoes that are presented in window 701.

In step 209, processor 15 populates second scrollable window 703 with default (predetermined) bottom dress items. User selectable tab 723 provides a selectable option list and is configurable using processor 34 to represent a different type of clothing such as sportswear, activity specific clothes and seasonal clothing, for example. User selectable tab 725 enables a user to access an option list for selection of all or one or more different sellers as sources of the bottom dress items to be shown in window 703. User selectable tab 728 enables a user to select via an option list, all or one or more categories of clothes subsequently shown in window 703 and user selectable tab 731 enables a user to select accessories including one or more of bags, scarves, gloves, jewelry, for example, that are presented in window 703.

In step 212, processor 15 presents a top dress item selected e.g. by user clicking on the item in window 701, in a matching zone as item 705, 709. In step 215, processor 15 presents a bottom dress item selected e.g. by user clicking on the item in window 703, in a matching zone as item 707, 711 below the top item 705. Top item 705 and bottom item 707 are presented with waists adjacent and of substantially the same size. In step 218, processor 15 presents shoes selected e.g. by user clicking on a shoe item in window 701, in a matching zone as item 744 and presents an accessory selected e.g. by user clicking on an accessory item (bag) in window 703, in a matching zone as item 742. In step 221, item data including one or more of an identifier, price, link to the item on a source seller web site, size and color availability is displayed in the single display image in response to user selection of a top, bottom, accessory or shoe item in the match zone or hovering a cursor over the item. The source seller web site enables a user to add the item to a cart and purchase the item via a checkout process. In another embodiment, the item data is displayed in the single display image in response to presentation of the item in the match zone. The process of FIG. 2 is repeated in response to user selection of different items in windows 701, 703.

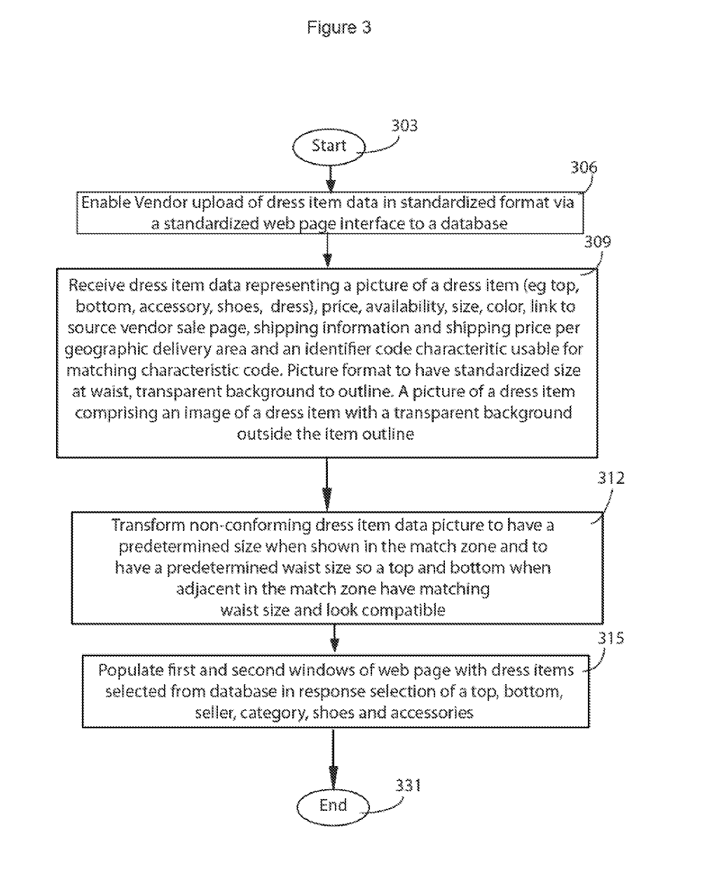

FIG. 3 shows a flowchart of a process used by system 10 (FIG. 1) for providing a clothing database in repository 17 used by the system for matching top and bottom dress items. In step 306, following the start at step 303 an interface enables a seller to upload dress item data via a standardized web page interface to a database in repository 17. In another embodiment, a user uploads data using a file such as a spreadsheet and CSV (comma separated values) file, for example. Processor 15 in step 309 receives the uploaded dress item (top, bottom, accessory, shoes, dress, for example) data including, picture of a dress item (e.g. JPEG, GIF, TIFF file) of standard pixel resolution and size and with a predetermined waist size. The picture of the dress item in one embodiment has a predetermined waist size of 1.25 inches when displayed and has a transparent background outside the item outline and is cropped close to the item outline. The uploaded dress item data also includes a seller dress item identifier, price, availability, link to the item on a source seller web site, size and color palette and availability, category, seller identifier and shipping charge per geographic delivery area. Individual dress items are allocated predetermined characteristic values based on at least one of color, shade, shape and pattern used for determining correlation of characteristic values of individual dress items to derive an indicator of degree of match of dress items in the match zone. The degree of match is derived based on a score calculated from correlation of the characteristic values of individual dress items. Alternatively, a best match or match value is determined by a user matching pairs of top and bottom items or a group of items of an outfit, for example, based on a predetermined score (100=a perfect match. 0=no match, for example) allocated to the match.

In step 312, processor 15 automatically transforms a non-conforming dress item picture by scaling and if needed, rotation and translation operations, to have the predetermined waist size when shown in the match zone and excludes need for a user to scale a dress item. The predetermined waist size facilitates visually matching of top and bottom items that are adjacent with top item above the bottom item in the match zone. In step 315, processor 15 populates window 701 with top dress items or shoes and populates window 703 with bottom dress items or accessories or other items in response to user selection via window 701, 703 and a tab command. The process of FIG. 3 terminates at step 331.

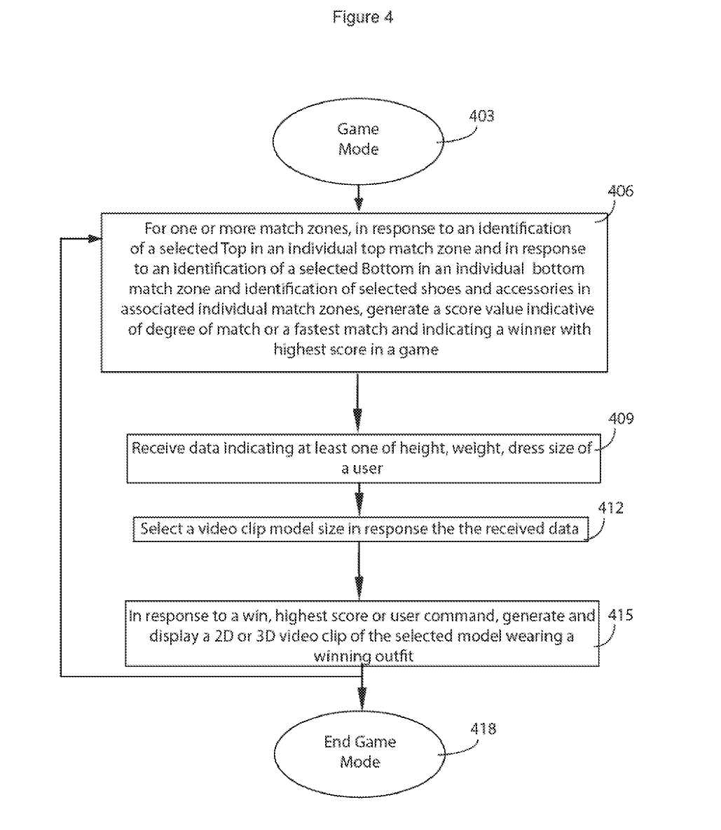

FIG. 4 shows a flowchart of a process used by system 10 FIG. 1 for providing a game. In step 406, following the start at step 403, in one embodiment, an initial dress item (e.g., top, bottom, dress, shoes, accessory) is provided by processor 15 (or by user selection in another embodiment) and a user is prompted to select the remaining best matching dress items to provide a complete outfit. In response to identification of a selected top dress item in an individual top match zone and identification of a selected bottom dress item in an individual bottom match zone, from predetermined multiple top and bottom dress items in windows 701, 703, processor 15 generates a score value indicative of degree of match of the selected top and bottom dress items. A winner has the highest matching score in the game. Processor 15 processes predetermined characteristic values that are allocated to top and bottom dress items and are based on at least one of color, shade, shape and pattern, and data indicating whether a top dress item is preferably matched with a skirt, trousers or shorts, for example. A top dress item characteristic value may also indicate a style of bottom dress item that is optimally matched with it. For example, the value may indicate a top is optimally matched with jeans of a particular fit such as loose or skinny fit.

Processor 15 processes the predetermined characteristic values to determine a correlation value of characteristic values of individual dress items to derive an indicator of degree of match of dress items in the match zone. Predetermined rules are used in determining the correlation including rules indicating which colors, shades, patterns clash and are incompatible and which are compatible and their degree of compatibility. Alternatively, a best match is determined from predetermined data identifying one or more particular top and bottom pairs as being best matches of the multiple tops and bottoms presented in windows in the single display image (100=a perfect match, 0=no match, for example). Similarly, a predetermined match score value indicating a match of a group of items may also be used. A best match involving shoes and an accessory is also determined from predetermined data based on color, pattern, shade compatibility as previously described, for example. In another embodiment, the single display image may include one or more matching zones and a player wins by compatibly matching dress items in the match zones fastest. A match of particular items is determined based on predetermined data for a pair or group of dress items.

In step 409, processor 15 receives user entered data indicating at least one of height, weight and dress size of a user and in step 412 processor 15 selects a model size for a pictorial representation of a human model in response to the received data. In step 415 in response to a win in a game, highest score or user command, display processor 36 provides data representing a two dimensional (2D) or three dimensional (3D) video clip on display 19 of the selected model wearing a winning matched outfit modeling the outfit in a walk on a fashion runway. Alternatively, a static model wearing the outfit may be displayed (the model is not shown to preserve drawing clarity). In another embodiment, a static model or video clip of a model is displayed in non-game mode to show a matched outfit to a user. The process of FIG. 4 terminates at step 418.

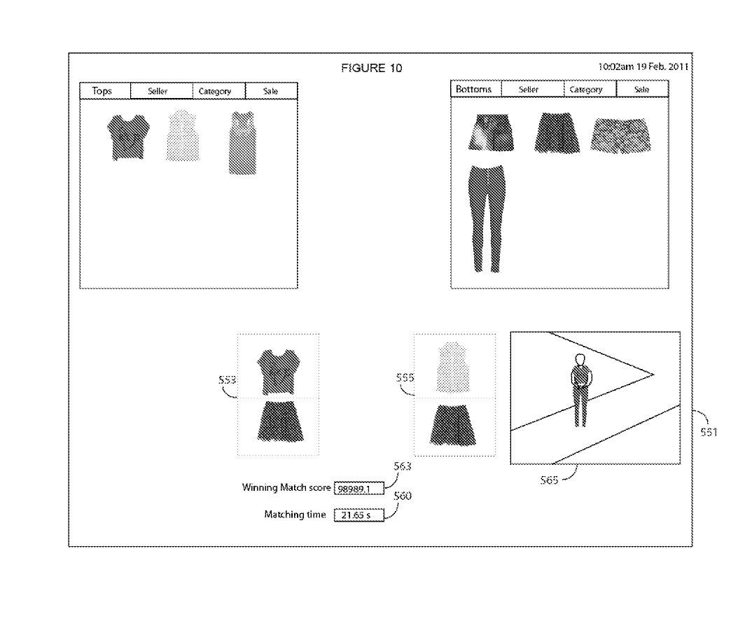

FIG. 10 shows single display image 551 for presenting multiple selected dress item matching zones 553, 555 for a game mode. In a game mode, one or more matching zones may be used. In a first game, a player with a highest cumulative matching score 563 wins. The cumulative matching score is derived for example from predetermined score data for pairs of tops and bottoms or groups of clothing items placed in the match zone. In a second game, a player wins by matching clothes in the top and bottom dress item windows fastest from start of item selection or another start time, and player time is measured in box 560. A match is determined, for example, from predetermined match or score data for pairs of tops and bottoms or groups of clothing items that indicate a particular top and bottom (or other item) match. In response to a win, or in response to user command or another condition a video clip of a model wearing a matched outfit parading up and down a fashion runway is shown in window 565. Alternatively, window 565 may display a model of a size compatible with user entered size data as a static image.

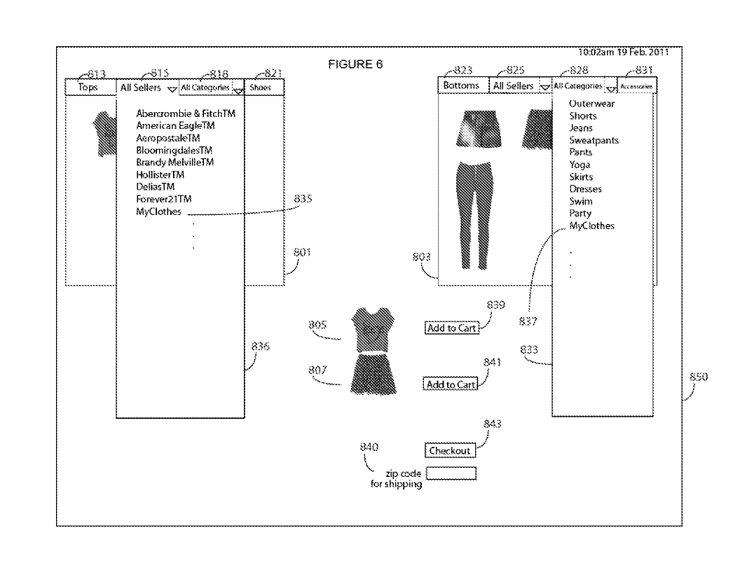

FIG. 6 shows single display image 850 presenting selected dress items adjacent illustrating seller and bottom dress item category selection and cart and checkout functions. Processor 15 (FIG. 1) populates first scrollable window 801 with default (predetermined) top dress items. User selectable tab 813 is a selectable option list and is configurable to represent a different type of clothing such as sportswear, activity specific clothes and seasonal clothing, for example. User selectable tab 815 enables a user to access option list 836 for selection of all or one or more different sellers (via checkboxes not shown to preserve drawing clarity) as sources of the top dress items shown in window 801. A user is able to select MyClothes item 835 to show previously stored pictures of user owned clothes in window 801 enabling a user to match an existing already owned clothes item (top) with a purchasable item (bottom). A mobile application enables a user in a store, for example, to advantageously show pictures of an existing clothes item adjacent a purchasable item to assess whether there is a match prior to purchase. User selectable tab 818 enables a user to select a category of clothes shown in window 801 and user selectable tab 821 enables a user to select shoes for presentation in window 801.

Processor 15 populates second scrollable window 803 with default (predetermined) bottom dress items. User selectable tab 823 provides a selectable option list and is configurable to represent a different type of clothing such as sportswear, activity specific clothes and seasonal clothing, for example. User selectable tab 825 enables a user to access an option list for selection of all or one or more different sellers as sources of the bottom dress items to be shown in window 803. User selectable tab 828 enables a user to select via an option list, all or one or more categories of clothes subsequently shown in window 803. User selectable tab 828 enables a user to access option list 833 for selection of all or one or more different clothes categories such as skirts (via checkboxes not shown to preserve drawing clarity) to be shown in window 803. A user is able to select MyClothes item 837 to show previously stored pictures of user owned clothes in window 803 enabling a user to match an existing already owned clothes item (bottom) with a purchasable item (top). User selectable tab 831 enables a user to select accessories including one or more of bags, scarves, gloves, jewelry, for example, for presentation in window 803. In an embodiment, display image 850 supports fulfillment of orders and advantageously enables a user to place a single order for different clothes items from multiple different sellers with free shipping, for example. A user is able to add top and bottom items 805 and 807 in the match zone to a cart via buttons 839 and 841 respectively and initiate checkout via button 843. Shipping charges are calculated from a zip code entered in box 840 by a user.

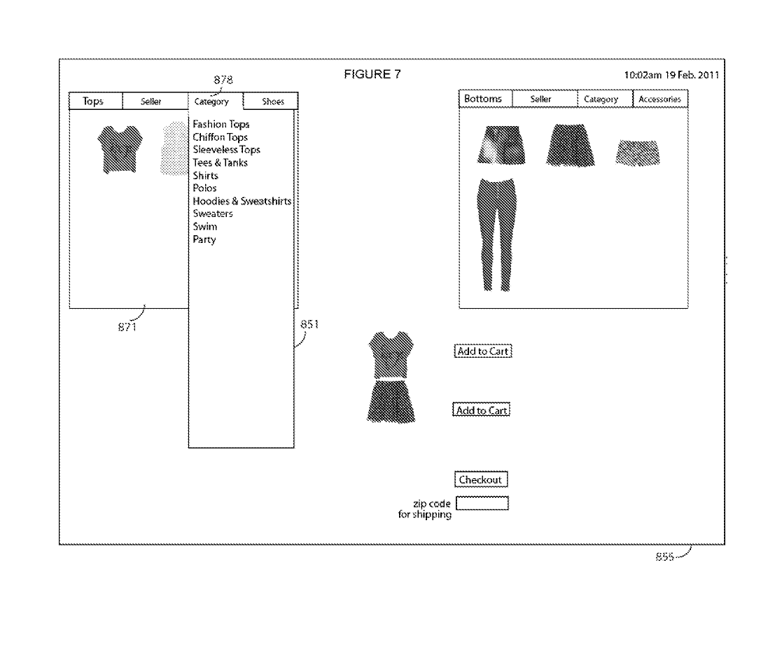

FIG. 7 shows single display image 855 presenting selected dress items adjacent illustrating top dress item category selection and cart and checkout functions. User selectable tab 878 enables a user to select via option list 851, all or one or more categories of clothes subsequently shown in window 871. User selectable tab 878 enables a user to access option list 851 for selection of all or one or more different clothes categories such as shirts (via checkboxes not shown to preserve drawing clarity) to be shown in window 871. A user may be able to select a MyClothes item (e.g. items 835, 837 FIG. 6) in a seller or category option list or another option list to show previously stored pictures of user owned clothes in a window enabling a user to match an existing already owned clothes item with a purchasable item.

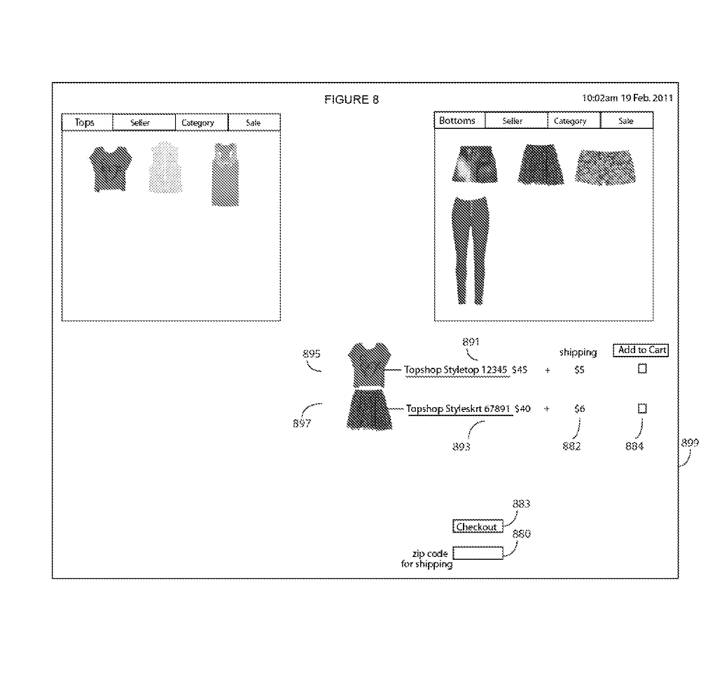

FIG. 8 shows single display image 899 for presenting selected dress items adjacent illustrating seller and top dress item selection for addition to a cart with shipping amounts. In this embodiment, a user is able to add top and bottom items 895 and 897 in the match zone to a cart via checkboxes 884 respectively and initiate checkout via button 883. Item 895 and 897 shipping charges 882 are calculated from a zip code entered in box 880 and shown together with prices, item identifier and link to a respective seller web page (891, 893).

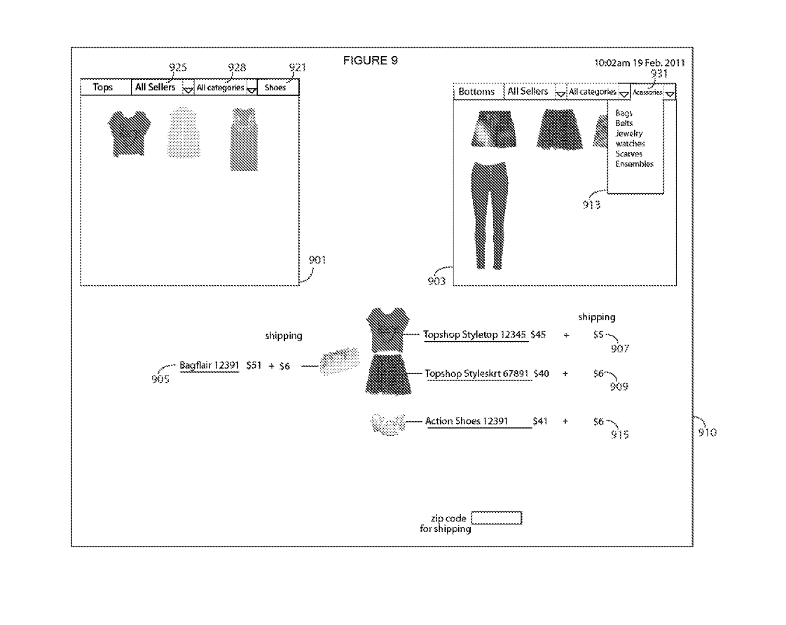

FIG. 9 shows single display image 910 presenting selected top and bottom dress items as well as shoes and accessories (bag) adjacent. Pictures of user selectable shoes are displayed in window 901 in response to user selection of tab 921. The shoes presented may be of a particular category and from one or more selected sellers in response to use of option lists presented by selection of tabs 925 and 928 in a manner as previously described. The items are shown in a match zone together with prices, item identifier and links to respective seller web pages (905, 907, 909 and 915). A user is able to select type of accessory displayed in window 903 from bags, belts, jewelry, watches scarves and ensembles of option list 913 for example, in response to selection of tab 931. An ensemble is a complete matching outfit including top, bottom, shoes and accessory or multiple matching items.

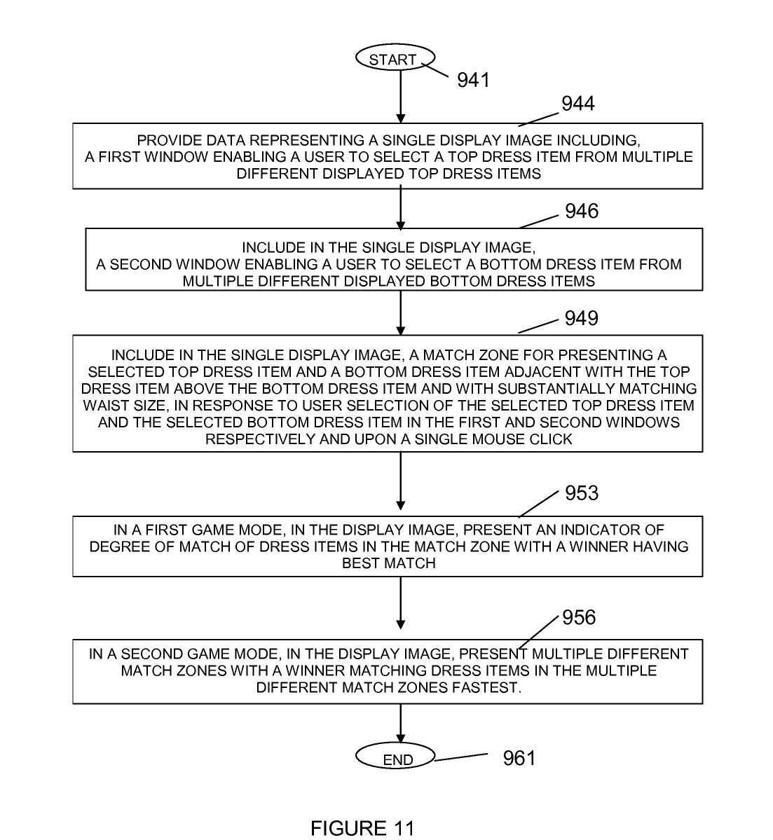

FIG. 11 shows a flowchart of a process used by a clothing style selection, matching and game system 10 (FIG. 1). In steps 944, 946 and 949 following the start at step 941 processor 15 (comprising one or more processing devices or computers) provides data representing a single display image. The single display image includes, a first scrollable window enabling a user to select a top dress item from multiple different displayed top dress items. The single display image also includes, a second scrollable window enabling a user to select a bottom dress item from multiple different displayed bottom dress items and a match zone. The match zone presents a selected top dress item and a bottom dress item with substantially matching waist size, adjacent and with the top dress item above the bottom dress item, in response to user selection of the selected top dress item and the selected bottom dress item in the first and second windows respectively.

The match zone presents a top dress item in response to a single mouse click selection of the top dress item in the first window and the match zone presents a bottom dress item in response to a single mouse click selection of the bottom dress item in the second window. The selected top dress item is presented in the match zone in proximity of an item identifier and a link to the selected top dress item on a seller web site. The selected bottom dress item is also presented in the match zone in proximity of an item identifier and a link to the selected bottom dress item on a seller web site. In one embodiment, the single display image enables a user to add at least one of the selected top dress item and the selected bottom dress item, to a cart for purchase. In a further embodiment, the match zone presents the selected top dress item and the bottom dress item on a representation of a human model. The single display image presents a video clip of the dressed model walking a fashion runway in response to a match, user command or winning a game. The dressed model size is selected in response to user entered size data.

The single display image, enables a user to select the top dress item from multiple different displayed top dress items of a particular seller and enables a user to select a bottom dress item from multiple different displayed bottom dress items of a particular seller. In one embodiment, the single display image enables a user to select the top dress item from multiple different displayed top dress items already owned by the user and enables a user to select a bottom dress item from multiple different displayed bottom dress items already owned by the user as well as shoes and accessories owned by the user. The single display image also enables a user to select shoes from multiple different displayed shoes and enables a user to select an accessory from multiple different displayed accessories. The match zone presents selected shoes and a selected accessory adjacent the selected top dress item and bottom dress item, in response to user selection of the selected shoes or accessory.

In an embodiment, individual dress items are allocated predetermined characteristic values based on at least one of color, shade, shape and pattern. The display image presents an indicator of degree of match of dress items in the match zone derived based on a score calculated from correlation of the characteristic values of individual dress items. In a first game mode in step 953 the single display image presents an indicator of degree of match of dress items in the match zone with a winner having best match. In a second game mode in step 956 the single display image presents multiple different match zones with a winner matching dress items in the multiple different match zones fastest. The process of FIG. 11 terminates at step 961.

The above-described embodiments can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity. No claim element herein is to be construed under the provisions of 35 U.S.C. 112, sixth paragraph, unless the element is expressly recited using the phrase “means for.” A “processor” as used herein comprises, a computer system circuit and device operating in response to instruction and is not just software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-11 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A clothing style selection and matching system concurrently displays windows enabling selection of items from each window for automatic presentation in a clothing match zone and in a game mode presents an indicator of degree of match of dress items in the match zone with a winner having best match and in another game mode displays different match zones with a winner matching dress items fastest. Further, the processes and applications may, in alternative embodiments, be located on one or more (e.g., distributed) processing devices on a network linking the units of FIG. 1. Any of the functions and steps provided in FIGS. 1-11 may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for.”

What is claimed is:

1. A clothing style selection and matching displayed interface provided in response to machine executable instructions stored in a tangible medium comprising:
data representing a single display image including,
a first window enabling a user to select a top dress item from a plurality of different displayed top dress items,
a second window enabling a user to select a bottom dress item from a plurality of different displayed bottom dress items and
a match zone for presenting a selected top dress item and a bottom dress item adjacent with said top dress item above said bottom dress item, in response to user selection of the selected top dress item and the selected bottom dress item in the first and second concurrently displayed windows respectively.

2. A medium according to claim 1, wherein
said match zone presents said selected top dress item and said bottom dress item with substantially matching waist size,
the first and second windows are scrollable and
said match zone presents a top dress item in response to a single mouse click selection of said top dress item in said first window and said match zone presents a bottom dress item in response to a single mouse click selection of said bottom dress item in said second window.

3. A medium according to claim 1, wherein
said single display image,
enables a user to select said top dress item from a plurality of different displayed top dress items of a particular seller and
enables a user to select a bottom dress item from a plurality of different displayed bottom dress items of a particular seller.

4. A medium according to claim 1, wherein
said single display image at least one of,
(a) enables a user to select said top dress item from a plurality of different displayed top dress items already owned by said user and
(b) enables a user to select a bottom dress item from a plurality of different displayed bottom dress items already owned by said user.

5. A medium according to claim 1, wherein
said single display image at least one of,
(a) enables a user to select shoes from a plurality of different displayed shoes and
(b) enables a user to select an accessory from a plurality of different displayed accessories and
said match zone presents at least one of, selected shoes and a selected accessory adjacent said selected top dress item and bottom dress item, in response to user selection of the selected shoes or accessory.

6. A medium according to claim 1, wherein
said single display image presents said selected top dress item and said bottom dress item on a representation of a human model.

7. A medium according to claim 6, wherein
said single display image presents a video clip of the dressed model walking a fashion runway.

8. A medium according to claim 6, wherein
the dressed model size is selected in response to user entered size data.

9. A medium according to claim 1, wherein
individual dress items are allocated predetermined characteristic values based on at least one of color, shade, shape and pattern and
said display image presents an indicator of degree of match of dress items in said match zone derived based on a score calculated from correlation of said characteristic values of individual dress items.

10. A medium according to claim 9, wherein
in a game mode, said single display image presents an indicator of degree of match of dress items in said match zone with a winner having best match.

11. A medium according to claim 1, wherein
in a game mode, said single display image presents a plurality of different match zones with a winner matching dress items in said plurality of different match zones fastest.

12. A medium according to claim 1, wherein
said selected top dress item is presented in said match zone in proximity of an item identifier and a link to said selected top dress item on a seller web site and
said selected bottom dress item is presented in said match zone in proximity of an item identifier and a link to said selected bottom dress item on a seller web site.

13. A medium according to claim 1, wherein
said single display image enables a user to add at least one of said selected top dress item and said selected bottom dress item, to a cart for purchase.

14. A method for clothing style selection and matching, comprising the activities of:
employing at least one processing device for,
providing data representing a single display image including,
a first window enabling a user to select a top dress item from a plurality of different displayed top dress items,
a second window enabling a user to select a bottom dress item from a plurality of different displayed bottom dress items and
a match zone for presenting a selected top dress item and a bottom dress item adjacent with substantially matching waist size, in response to user selection of the selected top dress item and the selected bottom dress item in the first and second windows respectively.

15. A method according to claim 14, wherein
said match zone presents said selected top dress item and said bottom dress item with said top dress item above said bottom dress item,
the first and second windows are scrollable and
said match zone presents a top dress item in response to a single mouse click selection of said top dress item in said first window and said match zone presents a bottom dress item in response to a single mouse click selection of said bottom dress item in said second window.

16. A method according to claim 1, wherein
said single display image,
enables a user to select said top dress item from a plurality of different displayed top dress items of a particular seller and
enables a user to select a bottom dress item from a plurality of different displayed bottom dress items of a particular seller.

17. A clothing style selection and matching game provided in response to machine executable instructions stored in a tangible medium comprising:
data representing a single display image including,
a first window enabling a user to select a top dress item from a plurality of different displayed top dress items,
a second window enabling a user to select a bottom dress item from a plurality of different displayed bottom dress items and
a match zone for presenting a selected top dress item and a bottom dress item adjacent with said top dress item above said bottom dress item, in response to user selection of the selected top dress item and the selected bottom dress item in the first and second windows respectively, wherein at least one of,
(a) said single display image presents an indicator of degree of match of dress items in said match zone with a winner having best match and
(b) said single display image presents a plurality of different match zones with a winner matching dress items in said plurality of different match zones fastest.

18. A medium according to claim 17, wherein
said match zone presents said selected top dress item and said bottom dress item with substantially matching waist size,
said match zone presents said selected top dress item and said bottom dress item on a representation of a human model.

19. A medium according to claim 18, wherein
said single display image presents a video clip of the dressed model walking a fashion runway.

20. A medium according to claim 18, wherein
the dressed model size is selected in response to user entered size data.

21. A medium according to claim 17, wherein
individual dress items are allocated predetermined characteristic values based on at least one of color, shade, shape and pattern and
said single display image presents said indicator of degree of match of dress items in said match zone derived based on a score calculated from correlation of said characteristic values of individual dress items.
